(19) United States
(12) Patent Application Publication
(10) Pub. No.: US 2005/0205405 A1
(43) Pub. Date: Sep. 22, 2005

(54) Dome sheet and method for manufacturing the same

(76) Inventors: Cheng-Pin Huang, Tu-chen (TW); Ssu-Min Lung, Tu-chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 11/025,484

(22) Filed: Dec. 28, 2004

(30) Foreign Application Priority Data
Mar. 19, 2004 (TW) 93107391

(51) Int. Cl. H01H 1/10

(52) U.S. Cl. 200/512

(57) ABSTRACT

A dome sheet for a panel switch includes a planar and resilient metal sheet (1), a number of domes (2) punched from the metal sheet, and a number of positioning members (3) made of insulative material for positioning the domes with the metal sheet. A manufacturing process for the dome sheet includes steps of processing a metal sheet to form a number of original domes (22) partially separate from the metal sheet, applying a plurality of positioning members to fix the original dome to the metal sheet, and electrically isolating the original dome from the metal sheet.

### BACKGROUND OF THE INVENTION

1. Field of the Invention

The present invention relates to a dome sheet for a panel switch and a panel switch using the same.

2. Description of the Prior Art

A conventional dome sheet is described in U.S. Pat. No. 5,986,228. The dome sheet comprises a plurality of dome-like movable contacts, a substrate sheet and a plurality of dustproof sheets corresponding to the dome-like movable contacts.

The substrate sheet defines a plurality of openings in predetermined locations, and the openings are larger than the dome-like movable contacts and smaller than the dustproof sheets in size. The dome-like movable contacts are received in the corresponding openings, and the dustproof sheets covers on the openings. The substrate sheet has a sliver layer provided on an upper surface thereof. The sliver layer is used to suppress an extraneous emission of electromagnetic waves and reduce an adverse effect of static electricity.

As described in the foregoing, the dome sheet is used in some electronic equipment, and in such equipment it is very important to suppress the extraneous emission of electromagnetic waves and reduce the adverse effect of static electricity. However, the sliver layer usually cannot meet such a high performance of the requirement.

Hence, an improved dome sheet is required to overcome the disadvantages of the prior art.

### BRIEF SUMMARY OF THE INVENTION

A main object of the present invention is to provide a dome sheet which has a simpler manufacture process and can save material.

Another object of the present invention is to provide a dome sheet which can achieve a higher performance in suppressing the extraneous emission of electromagnetic waves and reducing the adverse effect of static electricity. The present invention also provides a method for manufacturing a dome sheet corresponding this invention.

A dome sheet for a panel switch according to the present invention comprises a planar and resilient metal sheet, a plurality of domes punched from the metal sheet, and a plurality of positioning members made of insulative material for positioning the domes with the metal sheet. A method for manufacturing the dome sheet described in foregoing includes steps of processing a metal sheet to get a plurality of original domes and enabling the original domes to partially separate from the metal sheet, positioning the original dome on the metal sheet by a plurality of positioning members, and completely cutting the original dome from the metal sheet.

To compare with the conventional invention, the merit of this invention is that the dome sheet has the punched metal sheet, and uses the punched metal sheet to suppress the extraneous emission of electromagnetic waves and reduce the adverse effect of static electricity. This invention not only can achieve a high performance in foregoing aspects but also provide a simpler process and save much material.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a plan view of a dome sheet corresponding to this invention showing a first step of a process of producing the dome sheet;

FIG. 2 is a plan view of the dome sheet, showing a second step of the process;

FIG. 3 is a plan view of the dome sheet, showing a third step of the process; and

FIG. 4 is a cross-sectional view taken from line 4-4 of FIG. 3.

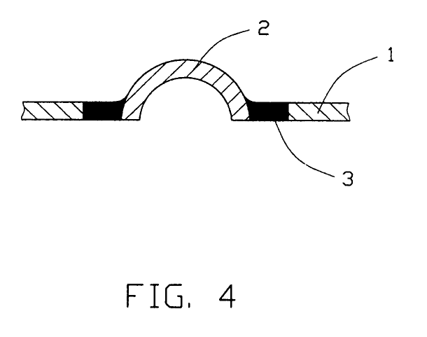

### DETAILED DESCRIPTION OF THE INVENTION

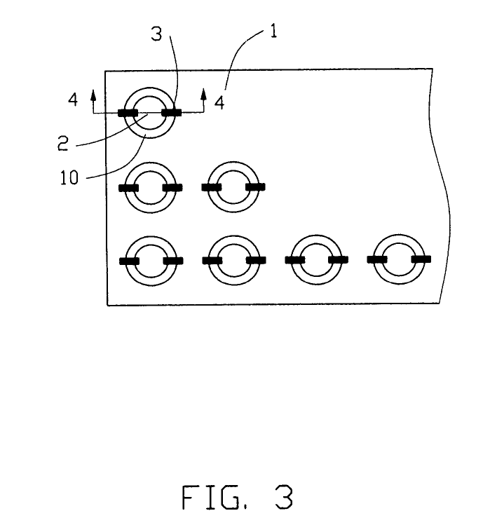

Referring to FIG. 3, a dome sheet in according with the present invention comprises a metal sheet 1, a plurality of domes 2 and a positioning member 3. The metal sheet 1 is a planar and resilient conductive sheet. The metal sheet 1 has a plurality of openings 10 corresponding to the plurality of domes 2 defined thereon in predetermined locations. The openings 10 are larger than the domes 2 in size and each receives one dome 2 therein. The domes 2 are punched from the metal sheet 1, and positioned on the metal sheet 1 by insert molding the positioning member 3. And also, the plurality of domes 2 can be positioned by coating film sheets thereon.

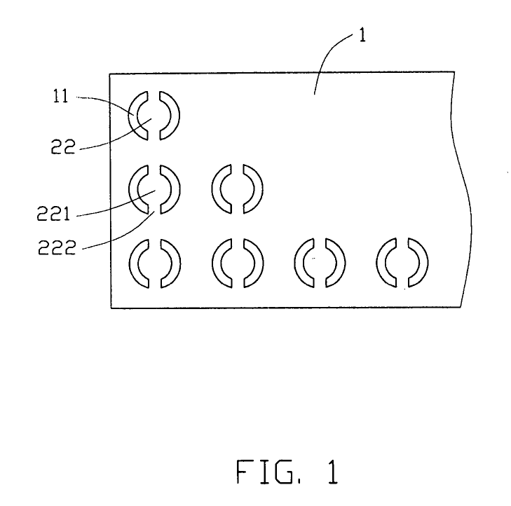

Referring to FIGS. 1-3, a process for manufacturing a dome sheet in according with the preset invention is shown. As is described in foregoing, the metal sheet 1 is substantially a planar and resilient conductive sheet. In a first step, the metal sheet 1 is punched and the original domes 22 are formed in predetermined locations of the metal sheet 1. A pair of C-shaped slits 11 is defined to surround each original dome 22. The original dome 22 has a central portion 221 and a pair of connecting portions 222 oppositely extending from the central portion 221 to interconnect the central portion 221 and the metal sheet 1.

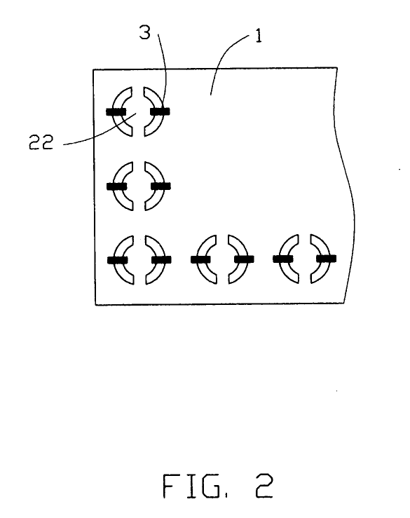

In a second step of the process, the positioning members 3 are made of insulative and adhesive material, which holds the original domes 22 by insert molding. The plurality of positioning members 3 are adhesive with metal sheet 1 and the corresponding original domes 22 and partially fill in the C-shaped slits 11. The purpose of this step is to hold the original domes 22 and to prevent the movement of the dome 2 relative to the metal sheet 1 in the following processing. The positioning member 3 used here, which is shown in FIG. 2, can be instead by any know manner, such as, by coating a plurality of film sheets on the original dome 22.

In a third step of the process, the connecting portions 222 of the original domes 22 are cut off. The original domes 22 are then separated from the metal sheet 1, which makes the domes 2.

As the metal sheet 1 is utilized to suppress the extraneous emission of electromagnetic waves and reduce the adverse effect of static electricity, the present invention can save much material, and achieve a high performance in foregoing aspect.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

1. A dome sheet for a panel switch comprising:
a planar and resilient metal sheet;
a plurality of domes separated from the metal sheet; and
a plurality of positioning members made of insulative material for connecting the plurality of domes with the metal sheet.

2. The dome sheet as claimed in claim 1, wherein the metal sheet has a plurality of openings provided in predetermined locations thereof, and each opening receiving a corresponding dome therein.

3. The dome sheet as claimed in claim 1, wherein the domes are punched from the metal sheet, and the domes have dome-like configurations.

4. The dome sheet as claimed in claim 1, wherein the plurality of positioning members position the plurality of domes to the metal sheet, and partially fill in the openings between the plurality of domes and the metal sheet.

5. A method for manufacturing a dome sheet comprising steps of:
processing a metal sheet to form a plurality of original domes partially separate from the metal sheet;
applying a plurality of positioning members to fix the original dome to the metal sheet; and
electrically isolating the original dome from the metal sheet.

6. The method for manufacturing a dome sheet as claimed in claim 5, wherein the step of processing comprises punching.

7. The method for manufacturing a dome sheet as claimed in claim 5, wherein the step of processing comprises forming a pair of C-shaped slits surrounding the original dome to partially separate each original dome.

8. A dome sheet for a panel switch comprising:
a planar metal sheet defining a plurality of openings therein;
a plurality of domes disposed in the corresponding openings, respectively, without radially touching the metal sheet so as to form an annular space between each of said domes and the metal sheet; and
a plurality of dielectric linking members disposed in the opening to link the domes with the metal sheet so as to allow the domes up and down moveable relative to the sheet.

9. The dome sheet as claimed in claim 8, wherein each of the domes is a part of the metal sheet before the corresponding annular space is formed.

10. The dome sheet as claimed in claim 8, wherein each of the domes is a part of the metal sheet and linked to the sheet by at least one strip when the corresponding annular space is initially formed, while said strip is removed after the corresponding dielectric linking member links the dome and the sheet together.
